(19) United States
(12) Patent Application Publication
(10) Pub. No.: US 2006/0004693 A1
(43) Pub. Date: Jan. 5, 2006

(54) GRAPHICAL USER INTERFACE FOR EXPLORING DATABASES

(75) Inventors: Sujatha Ramanathan, Schenectady, NY (US); Chanchal Gupta, Schenectady, NY (US)

Correspondence Address: NIXON & VANDERHYE P.C., 901 NORTH GLEBE ROAD, 11TH FLOOR, ARLINGTON, VA, 22203, US

(73) Assignee: GENERAL ELECTRIC COMPANY, Schenectady, NY (US)

(21) Appl. No.: 10/709,616

(22) Filed: May 18, 2004

(51) Int. Cl. G06F 17/30

(52) U.S. Cl. 707/2

(57) ABSTRACT

In a computer system, a method of searching through metadata from a plurality of data tables concurrently, the data tables being defined by a schema and stored in a database(s) is provided. The method comprises generating a graphical user interface, the graphical user interface having at least one item including a predefined instruction label which is associated with a corresponding SQL query for defining a search through the metadata from the plurality of data tables; receiving user input, through the graphical user interface, selecting the schema and selecting the item having the predefined instruction label; and processing the received user input so as to conduct a concurrent search through metadata from the plurality of tables, the type of search being based on the selected item having the predefined instruction label.

### BACKGROUND OF INVENTION

The present invention relates to a graphical user interface (GUI) for exploring data stored in one or more databases. In particular, the present invention relates to a GUI for concurrently browsing metadata from multiple data tables stored in a particular one of the databases.

It is often necessary to find and retrieve information stored in one or more databases. Unfortunately, finding and retrieving desired information may not be easy or efficient, particularly when the location of the information is unknown. The location of information being or becoming unknown often occurs when the databases are part of a legacy software application or a software application with inadequate documentation or available support. For example, the application developers or other people having knowledge about a particular software application and its underlying process, data structure or business model may be completely unavailable or available only on a limited basis. Finding the location of the desired information may be even more difficult if there are a large number (e.g., hundreds or even thousands) of databases, each potentially storing the desired information, that must be searched. Moreover, the various databases may also be stored by servers having different data platform formats (e.g., Oracle®, Sybase® or MS-Access®).

Data stored in a particular database may be organized into tables as defined by a schema of the database. Each of these tables may include one or more columns (fields). A schema of the database defines the tables, columns in each table and the relationships between the tables and columns. Multiple schemas can be defined for the same database and a single table may be associated with multiple schemas. Metadata, i.e. data about data, is also defined for each database and its tables and columns.

In order to search for information stored in a database, a user would conventionally be forced to search one column of one table at a time. That is, the search would involve searching for the desired information in one table on a column-by-column basis. If all of the columns in that particular table have been searched without finding the desired information, the next table of the database will be searched on a column-by-column basis.

The efficiency of the search for desired information could be greatly enhanced if the user knew metadata about the database such as the table names and column names before initiating the search. However, as noted above, this type of information may not be readily available due to inadequate documentation and/or support. While the column names of a particular table may be viewed upon opening the table, each table will have to first be opened to determine its contents including column names. Opening each table must therefore be accomplished on a repeated basis until the desired information is located. While it is possible to construct a standard query language (SQL) query to search for metadata of the database, this requires the user to possess detailed knowledge of cryptic SQL commands.

It would therefore be beneficial to provide a database browser which is capable of efficiently searching metadata of a database without requiring the user to possess detailed knowledge of SQL. The database browser could therefore be operated in a relatively simple, user-friendly manner to conduct a search of metadata. It would also be beneficial able to use one instance of the same database browser to access data from various sources including sources having different data platforms (e.g., Oracle® Sybase® or MS-Access®) and to be able to present data in multiple formats such as in a dynamic chart once desired information is extracted from the database(s). Exemplary embodiments of the present invention provide such benefits.

### SUMMARY OF INVENTION

In a computer system, a method of searching through metadata from a plurality of data tables concurrently, the data tables being defined by a schema and stored in a database(s), is provided. The method comprises generating a graphical user interface, the graphical user interface having at least one item including a predefined instruction label which is associated with a corresponding SQL query for defining a search through the metadata from the plurality of data tables; receiving user input, through the graphical user interface, selecting the schema and selecting the item having the predefined instruction label; and processing the received user input so as to conduct a concurrent search through metadata from the plurality of tables, the type of search being based on the selected item having the predefined instruction label.

Each of the tables may include at least one column and the concurrent search through metadata from the plurality of tables may involve concurrently searching for column names of the plurality of tables defined by the schema.

The graphical user interface may include a user select menu allowing selection of the item having the predefined instruction label associated with the corresponding SQL query from among a list having at least one other item having another predefined instruction label associated with another SQL query. Data obtained as a result of the search may be output in a dynamic chart.

The SQL query associated with the predefined instruction label of the selected item may be displayed in a window defined by the graphical user interface, the SQL query being modifiable through change(s) input through the window or through a separate SQL query modification window also defined by the graphical user interface.

### BRIEF DESCRIPTION OF DRAWINGS

These and other benefits, features, aspects and advantages of the exemplary embodiments of the present invention will become more apparent from the following detailed description of the present invention when taken in conjunction with the accompanying drawings.

FIG. 1 is a diagram showing a system for browsing data using a graphical user interface (GUI) in accordance with an exemplary embodiment of the present invention;

FIG. 2 is a screen display of a GUI in accordance with an exemplary embodiment of the present invention;

FIG. 3 is an exemplary screen display of a GUI illustrating results from a selection of a schema and a particular table of the schema;

FIG. 4 is an exemplary screen display of a GUI which presents a menu of predefined instruction labels and corresponding SQL queries for browsing metadata;

FIG. 5 is an exemplary screen display of a GUI resulting from the selection of a predefined instruction label and corresponding SQL query and subsequent modification of the SQL query;

FIG. 6 is another exemplary screen display of the GUI resulting from the selection of a predefined instruction label and corresponding SQL query and subsequent modification of the SQL query;

FIG. 7 is an exemplary screen display of a GUI resulting from the selection of the button “XML” in the display screen illustrated in any one of FIGS. 2-6;

FIG. 8 is an exemplary screen display of a GUI resulting from the selection presented in FIG. 7;

FIG. 9 is an exemplary screen display of a GUI illustrating results from execution of an SQL query that has been modified;

FIG. 10 is an exemplary dynamic chart resulting from the selection of the button “Chart” in FIG. 9;

FIG. 11 is an exemplary screen display of a GUI including a further modification of the SQL query presented in the “Queries” window presented in FIG. 9; and

FIG. 12 is an updated dynamic chart output from the system resulting from the selection of the button “Chart” in FIG. 11.

### DETAILED DESCRIPTION

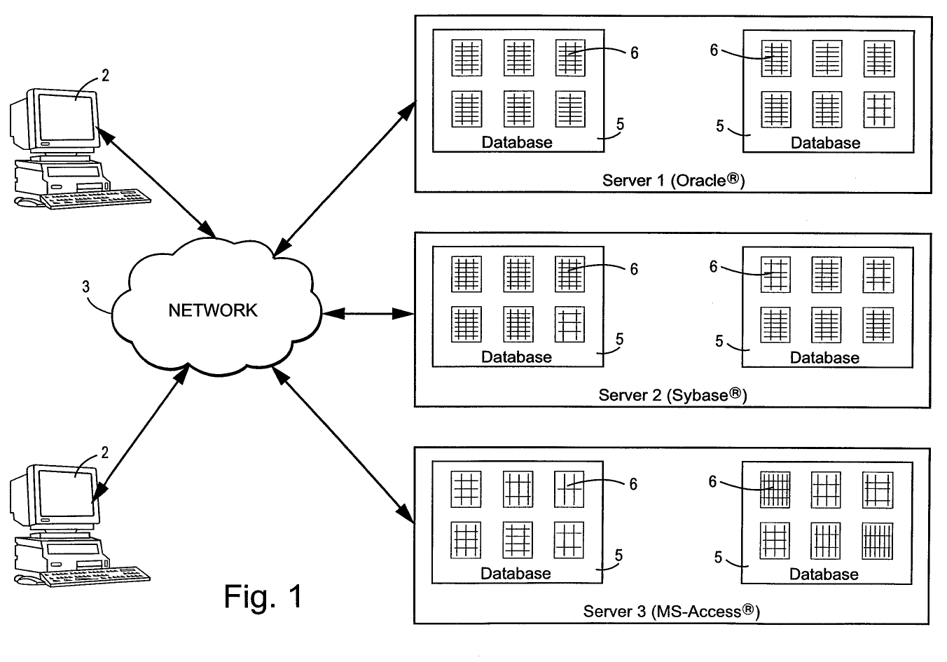

FIG. 1 is a diagram of a computer system for implementing a graphical user interface (GUI) for browsing data stored in one or more databases in accordance with an exemplary embodiment of the present invention. The system includes a network 3 interconnected to personal computers 2. Network 3 is also interconnected to server computers (servers 1-3). Network 3 enables communications between any one of personal computers 2 and any one of the server computers (servers 1-3). Network 3 may be formed by, for example, a LAN or a WAN such as the internet.

Each of the servers may have access to one or more databases 5. Each of databases 5 may contain one or more tables 6, each table 6 containing one or more columns, as defined by respective schemas. Each of databases 5 may be organized in a different data platform format. For example, as illustrated in FIG. 1, the databases accessible by server 1 may be organized in an Oracle® format, while the databases accessible by servers 2 and 3 contain a Sybase® and MS-Access® formats, respectively.

Each of personal computers 2 is capable of executing a software program for forming a GUI to enable the personal computer 2 to communicate, locally or remotely, with a particular server. In particular, the GUI executed by personal computers 2 allows respective users to search through (browse) data stored in the databases in a relatively simple and user-friendly manner.

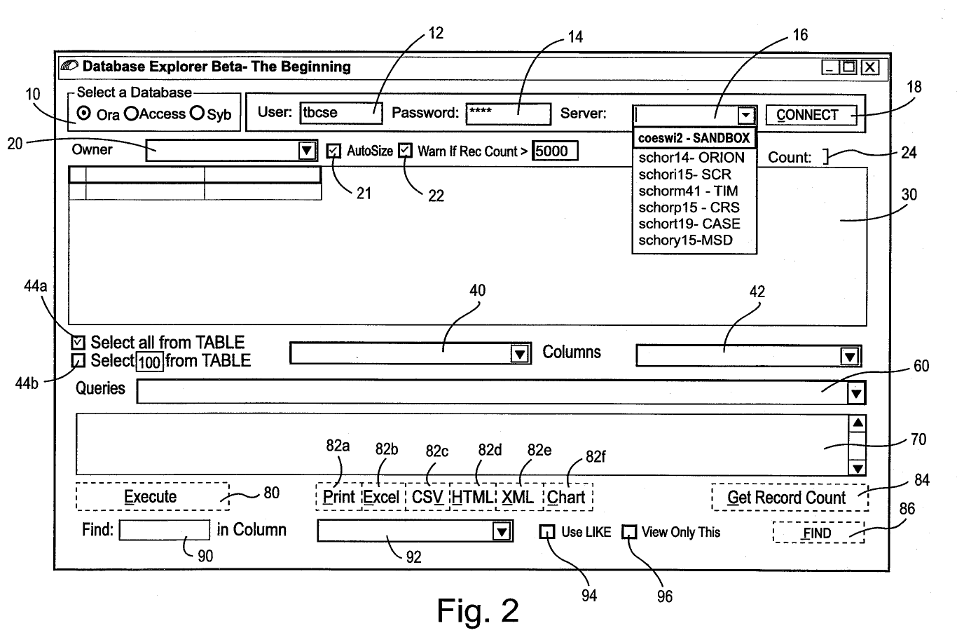

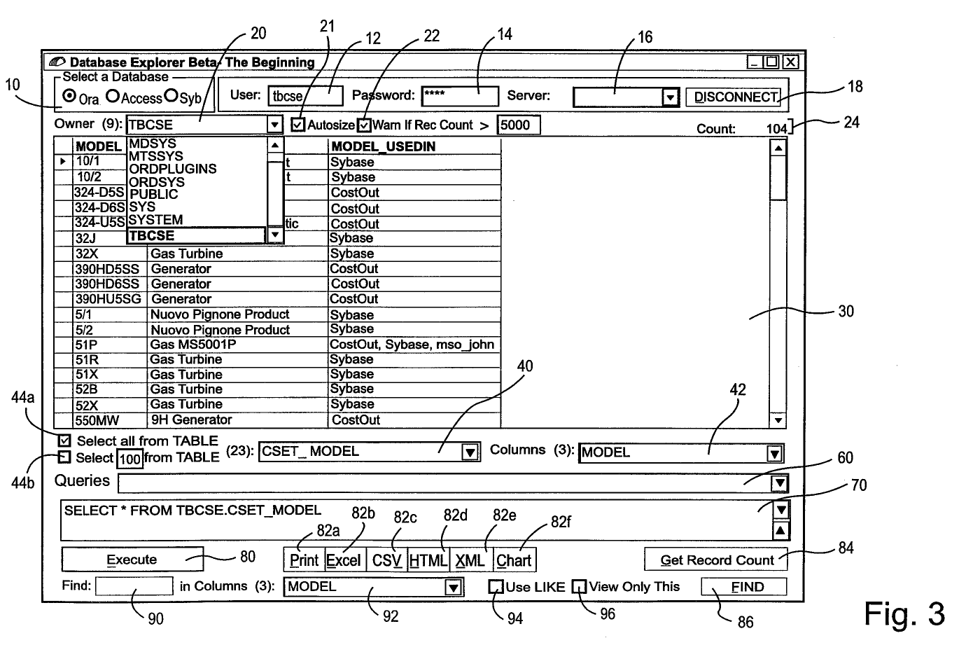

FIGS. 2-3 illustrate an exemplary screen display of the GUI which enables personal computers 2 to search through data stored in one or more of databases 5. The GUI includes a row selector 10 for allowing the user at personal computer 2 to select a particular database platform format. In particular, row selector 10 of the GUI allows a user to select from and switch between (in a single instance of the GUI) an Oracle® database platform format, and MS-Access® database platform format or a Sybase® database platform format. The GUI also includes a user input window 12, a user password input window 14 and a data source input window 16. The data source input window 16 may be formed in an exemplary embodiment by a drop down menu which allows the user to select from among one or more predefined servers as illustrated in FIGS. 2-3. After a user has selected a format of database platform in row selector 10 and provided appropriate inputs to windows 12, 14 and 16, the user may select connect button 18 to gain access to the selected data source. Access to the selected data source will, however, be only granted to the user if the user has been authorized as having access privileges to that data source. That is, an authorized user name and corresponding password must be entered into windows 12 and 14, respectively, for the user to have access.

Assuming that the user has appropriate access privileges, the selected data source and network 3 communicate a transmission to the personal computer 2 operated by the user which enables all of the schemas associated with the selected data source to be displayed in the GUI. In particular, the GUI includes schema window 20 which lists in a drop down menu all of the available schemas associated with the selected data source (e.g., selected server) and the number of available schemas (in this example, nine “owners” or schemas are available as illustrated in FIG. 3). Each schema defines the organization of a database, including defining the database's tables, the columns in each table and the relationships between the columns and tables.

The user may select one of the schemas listed in the drop down menu of schema window 20. As illustrated in FIG. 3, for example, schema “TBCSE” has been selected from among the nine schemas available for the selected data source.

Once the schema is selected from the drop down menu of schema window 20, the server computer interconnected by network 3 to the personal computer 2 operated by the user provides data so that the tables associated with the selected schema are presented in table window 40. The number of available tables (in this example, 23 tables are available as illustrated in FIG. 3) associated with the selected schema is displayed by the GUI on the immediate left of table window 40. A user may then select one of the available tables using the drop down menu in table window 40. In the GUI illustrated in FIG. 3, for example, table “CSET_MODEL” has been selected by the user from the menu in table window 40.

Upon the selection of a particular table in table window 40, the server and network 3 provide data to personal computer 2 to allow the names of the columns of the selected table to be displayed in columns window 42. The number of columns (in this example, three columns) forming the selected table is displayed by the GUI on the immediate left of columns window 42. If the user were to select a different table in table window 40, the names of the columns presented in columns window 42 and the number of columns presented at the immediate left of columns window 42 will automatically change to reflect the column names and number of columns of the newly selected table in table window 40.

The GUI also includes a SQL query window 70. An SQL query may be automatically formed and presented in SQL query window 70. In particular, an SQL query can be automatically formed if one of the selection boxes 44a and 44b is selected by the user. By selecting selection box 44a, a SQL query may be automatically formed based on the table selected by the user in table window 40 and the schema selected in schema window 20. For example, as illustrated in FIG. 3, the SQL query “SELECT*FROM TBCSE.CSET_MODEL” is automatically formed and presented in SQL query window 70 based upon the user selection of (i) selection box 44a, (ii) schema “TBCSE” in schema window 20 and (iii) table “CSET_MODEL” in table window 40. Alternatively, an SQL query requesting only a limited number (e.g., no more than 100 as illustrated in FIG. 3) of records may be automatically formed and presented in SQL query window 70 if selection box 44b is selected. The limit on the number of records formed through the selection of box 44b may be adjusted by the user. Limiting the number of records allows the user to quickly browse through the tables defined by a schema.

Accordingly, SQL query window 70 is a dynamic window which automatically forms and presents SQL queries based upon the selection of boxes 44a or 44b, schema selected in schema window 20 and table selected in table window 40. If the user were to select a different table in table window 40, the SQL query presented in SQL query window 70 would automatically change to reflect the newly selected table. If the user were to select a different schema in schema window 20, the SQL query presented in SQL query window 70 would automatically change to reflect the newly selected schema and any table associated with the newly selected schema that is selected in table window 40.

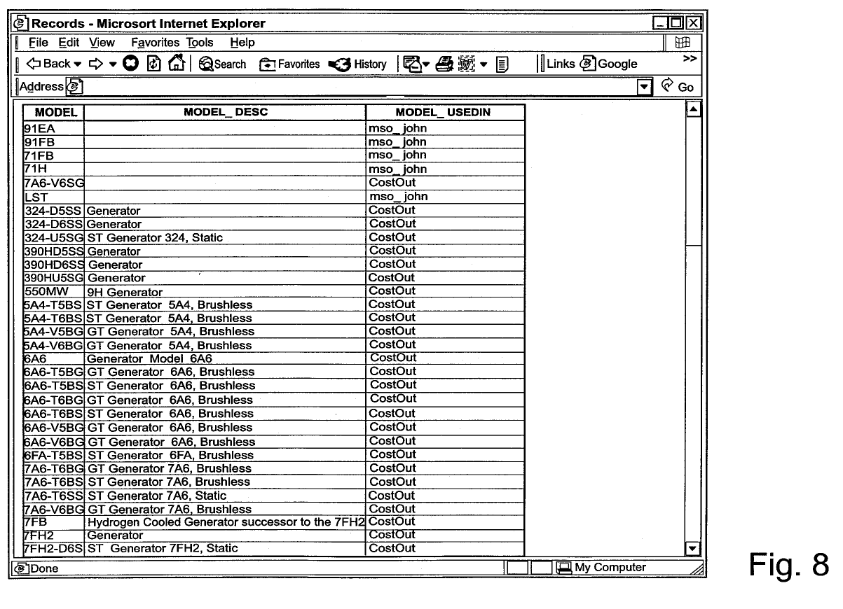

The SQL query is automatically processed and the results of the SQL query formed and presented in SQL query window 70 are automatically presented in dynamic display grid 30. For example, as illustrated in FIG. 3, display grid 30 presents the three columns “MODEL”, “MODEL_DESC” (see FIG. 8) and “MODEL_USEDIN” of table “CSET_MODEL” selected in table window 40 of schema “TBCSE” selected in schema window 20. If the selection of a particular schema and/or table in windows 20 and 40 were changed, the SQL query presented in SQL query window 70 would automatically change as would the results of that new SQL query in display grid 30.

The format of display grid 30 may be appropriately formatted if auto size box 21 is checked by the user. In particular, checking select box 21 will enable the results presented in display grid 30 to be resized based on the maximum number of records. By checking select box 22, display grid 30 may present a warning if the number of records of the selected table exceeds a predetermined threshold (e.g., a warning may be issued if the number of records of the selected table exceeds 5,000 as illustrated in FIG. 3). The count of the number of records in the processed SQL query is presented in a count display 24. For example, the number of records (rows) in display grid 30 in FIG. 3 resulting from the processed SQL query is 104 as shown by count display 24. A user may find out how many records would result from a particular query without actually executing it by selecting record count button 84.

The SQL query in SQL query window 70 may be modified by the user by directly changing the text of the SQL query presented in SQL query window 70. After the text of the SQL query has been modified in window 70, the modified SQL query may be executed upon the selection of execute button 80. The results of the modified SQL query will be presented in display grid 30. Count display 24 will also be updated.

In order to modify the text directly in SQL query window 70, a user must have a knowledge of SQL. Instead of directly modifying the text of the SQL query in SQL query window 70, a user may modify the SQL query by inputting an appropriate word in find window 90 and columns window 92. For example, if a user wanted to modify the SQL query in window 70 to find the term “390HD5SS” in the column named “MODEL”, the user can enter the term “390HD5SS” in window 90 and select the column name “MODEL” in columns window 92 and then select find button 86. If the term entered in find window 90 is to be found only upon an exact match in the column selected in columns window 92, the user can select the “View Only This” box 96. Alternatively, the “use like” box 94 may be checked to enable the user to find terms that are merely similar to the term entered in find window 90 and located in the column selected in columns window 92. When find button 86 is selected, the text of the SQL query in SQL query window 70 will be modified based on the selections in windows 90 and 92, and boxes 94 and/or 96. The results of the modified SQL query will then be processed and automatically displayed in display grid 30. Accordingly, an SQL query may be originally formed and executed through the selections in boxes 44a, 44b and windows 20 and 40. No extensive knowledge of SQL is needed to form and execute the SQL query in SQL query window 70. This SQL query in window 70 may then be modified via appropriate input in windows 90 and 92 and selection of boxes 94 or 96. A user may thus form and modify an SQL query without having extensive knowledge of SQL itself. The GUI of the present invention therefore provides a user friendly way of forming, modifying and executing SQL queries to search for and find data.

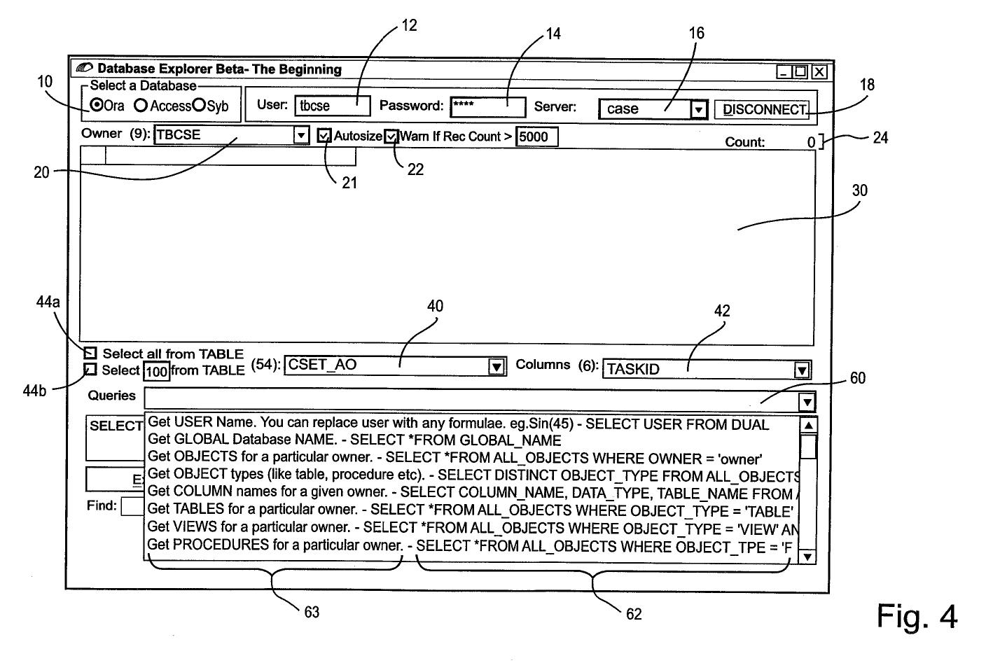

As illustrated in FIGS. 4-6, the GUI further includes a metadata queries window 60. Metadata queries window 60 presents a drop down menu listing a plurality of items for selection by the user. Each item includes a predefined SQL query 62 for searching through or for metadata of the selected data source, schema and/or table and corresponding predefined instruction label 63. Each of the SQL queries 62 of an item is associated with a corresponding predefined instruction label 63 which describes in common language the type of metadata search to be performed upon selection of the item. For example, the predefined instruction label “Get COLUMN names for a given owner” describes in common language an associated SQL query for concurrently searching for all of the column names for a given owner (i.e., a given schema selected in window 20). A metadata search may therefore be performed in which metadata, in this case column names, may be searched over a plurality of tables of the selected schema concurrently. As yet another example, the description label “Get TABLES for a particular owner” describes in common language an associated SQL query for performing a metadata search which enables all of the table names for a particular owner (i.e., a particular schema selected in window 20) to be executed. Any one of the items having predefined instruction labels 63 and corresponding SQL queries 62 for searching metadata can be selected by the user. Because the predefined instruction labels 63 describe in common language the type of SQL query that will be performed upon selection, the user does not need to possess an extensive knowledge of SQL to be able to conduct a search of metadata.

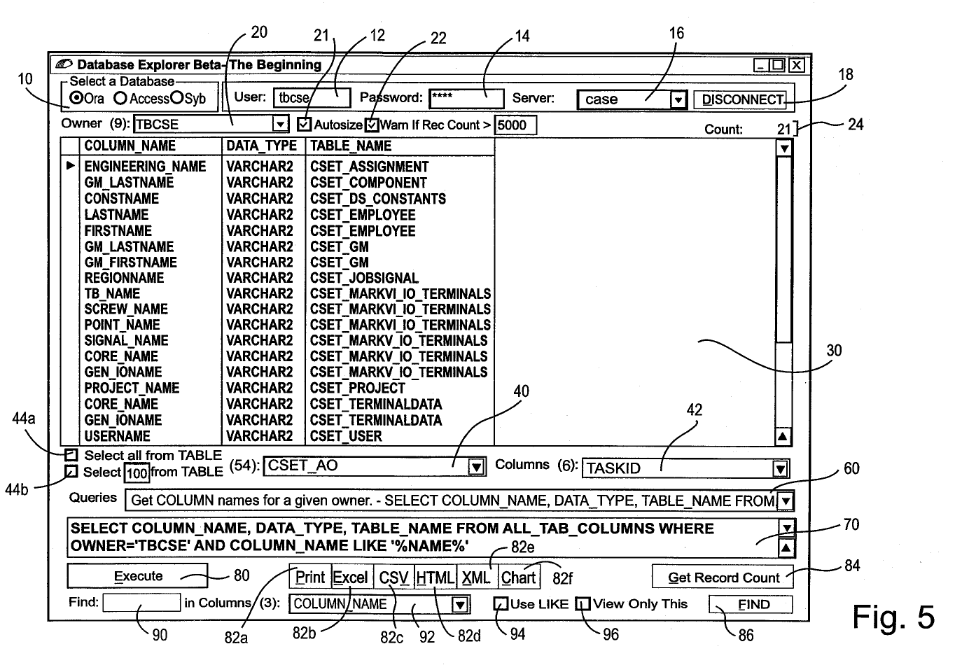

In operation, as long as the user has not selected one of boxes 44a or 44b (contrast FIGS. 4-5 with FIGS. 2-3), the user may select one of the items in metadata queries window 60. The user may thus execute a SQL query for searching through metadata of the selected data source, schema and/or table in a user-friendly manner since an extensive knowledge of SQL itself is not required. If one of boxes 44a or 44b is selected, then an SQL query is defined based on the selected box 44a or 44b, the selected schema in schema window 20 and the selected table in table window 40 as discussed above in connection with FIG. 3.

Once a user selects one of the items having a predefined descriptive label 63 and associated SQL query 62 for performing metadata searching from metadata queries window 60, the associated SQL query 62 is automatically presented in SQL query window 70. The SQL query is automatically processed and the results of the processed SQL query in window SQL query 70 is dynamically presented in display grid 30. For example, if the user selects the item having descriptive label “Get COLUMN names for a given owner” in metadata queries window 60 after previously selecting schema “TBCSE” in schema window 20, the SQL query associated with the descriptive label “Get COLUMN names for a given owner” will be defined as “SELECT COLUMN_NAME, DATA_TYPE, TABLE_NAME FROM ALL_TAB_COLUMNS WHERE OWNER=“TBCSE”” and automatically generated and presented in window 70. The results of this SQL query is then automatically presented in display grid 30. This SQL query thus enables metadata such as column names for multiple tables of a given schema to be simultaneously searched.

FIG. 5 is a display screen of a GUI in which an SQL query is effectively selected by selecting an item having the SQL query and its associated descriptive label (e.g., “Get COLUMN names for a given owner”) from metadata queries window 60. Upon selection, the SQL query is generated and presented in SQL query window 70. As illustrated in FIG. 5, the user may then modify the text of the SQL query in window 70 directly. In the example illustrated in FIG. 5, the user has typed “AND COLUMN_NAME LIKE “%NAME%”” at the end of the text presented in SQL query window 70. Upon selection of the execute button 80, display grid 30 and record count 24 are updated to reflect the changes made to the SQL query. In the example illustrated in FIG. 5, all of the column names possessing the term “%NAME%” is thus displayed in display grid 30.

If the user did not possess an extensive knowledge of SQL, the user could have modified the SQL query in window 70 to perform the above modified search by inputting “name” in find window 90, inputting “COLUMN_NAME” in columns window 92, and selecting “USE LIKE” button 94 and then find button 86. Accordingly, through inputs in windows 90 and 92, and selection of either box 94 or 96 and then find button 86, the metadata SQL query originating from the selection of an item having a descriptive label 62 in metadata queries window 60 may be modified in the manner illustrated in FIG. 5. Display grid 30 and record count 24 will be updated in accordance with the modified SQL query upon selection of the find button 86.

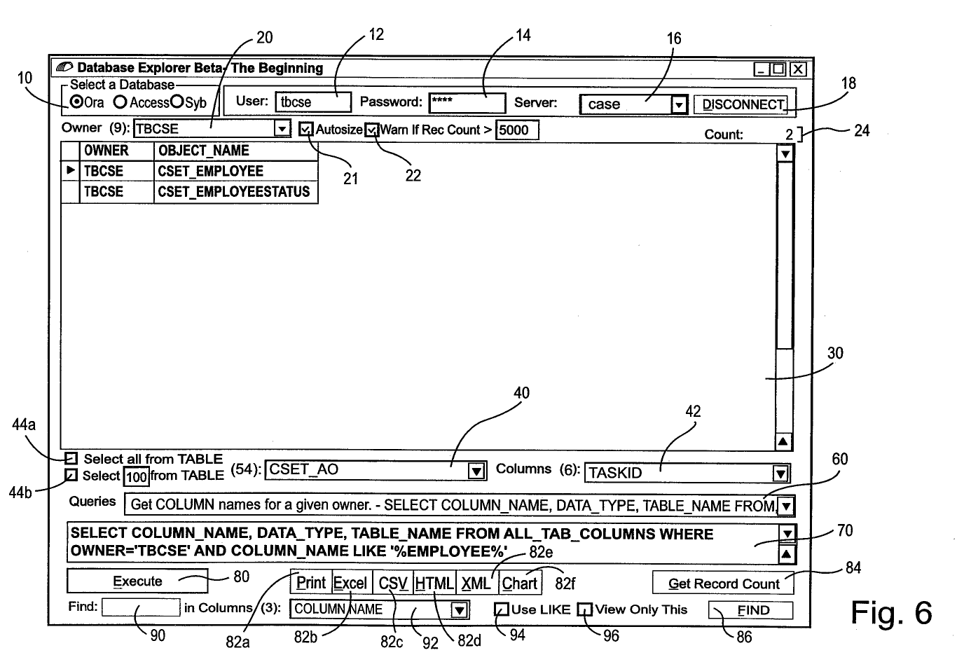

FIG. 6 is yet another example of a screen display of the GUI in which the user operating personal computer 2 first selected the item having predefined descriptive label “Get COLUMN names for a given owner” and corresponding SQL query in metadata queries window 60, and then modified the SQL query in window 70 resulting from the selection of the item by adding the text “AND COLUMN_NAME LIKE “%EMPLOYEE%”” in SQL query window 70. This modification to the SQL query may be made by inputting the text directly into window 70 if the user possesses a knowledge of SQL or through appropriate input of “employee” in find window 90, “COLUMN_NAME” in columns window 92, and selection of “Use Like” box 94 and find button 86. The user may thus modify the search through metadata selected from metadata queries window 60 via appropriate input in windows 90, 92, and selection of boxes 94 or 96 and find button 86 without possessing an extensive knowledge of SQL. Display grid 30 shows the results of the modified SQL query.

The information extracted from the selected data source, schema and tables may be presented in multiple formats including: a spreadsheet such as Excel®, CSV text files, HTML, XML or dynamic charts. The extracted data may be presented in multiple formats through selection of one of the buttons 82a-82f. Specifically, if the user wishes to simply print the extracted data (e.g., the data presented in display grid 30), the user may select button 82a. If the user would like to present the extracted data in a spreadsheet format such as Excel®, the user can select button 82b. If the user wishes to present the extracted data in a comma-separated text file, the user may select CSV button 82c. If the user wishes to present the extracted data in either an HTML or XML format, user may select button 82d or 82e, respectively. Finally, if the user wishes to present the data in a dynamic chart, the user can select button 82f.

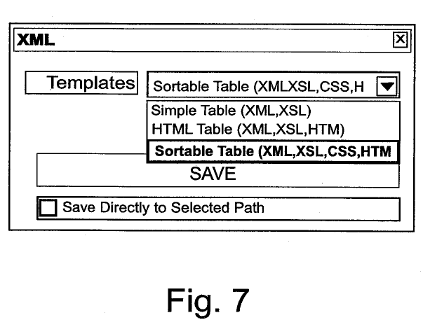

FIG. 7 illustrates a exemplary screen display of the GUI upon the selection of button 82e and after a particular SQL query has been processed. As illustrated in FIG. 7, the user may select from a number of different available tables. FIG. 8 illustrates the display of a particular table executed query upon the selection of “Sortable Table (XML, XSL, CSS, HTM . . . )” in FIG. 7.

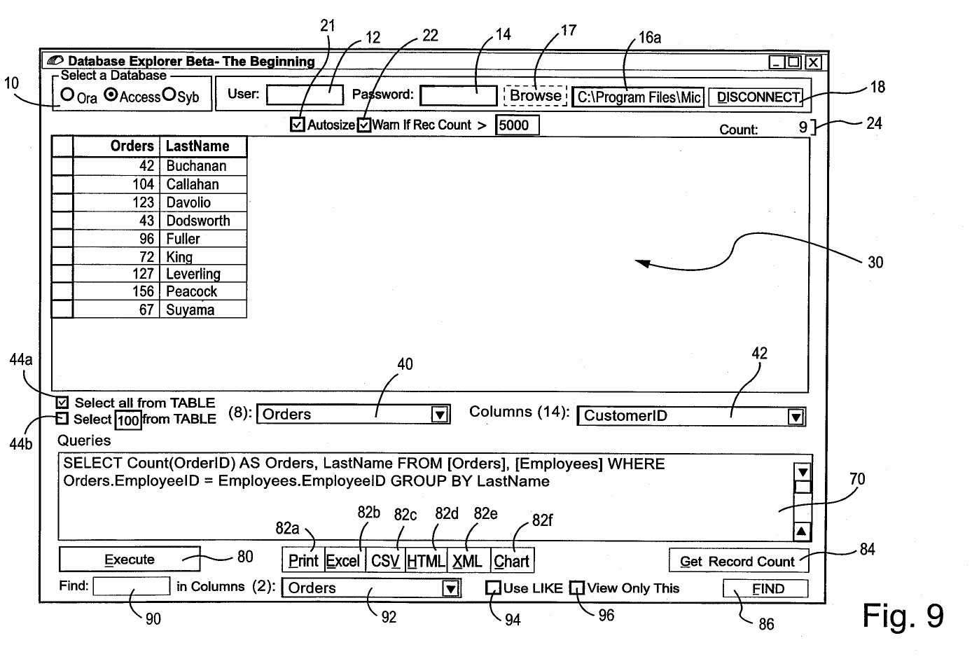

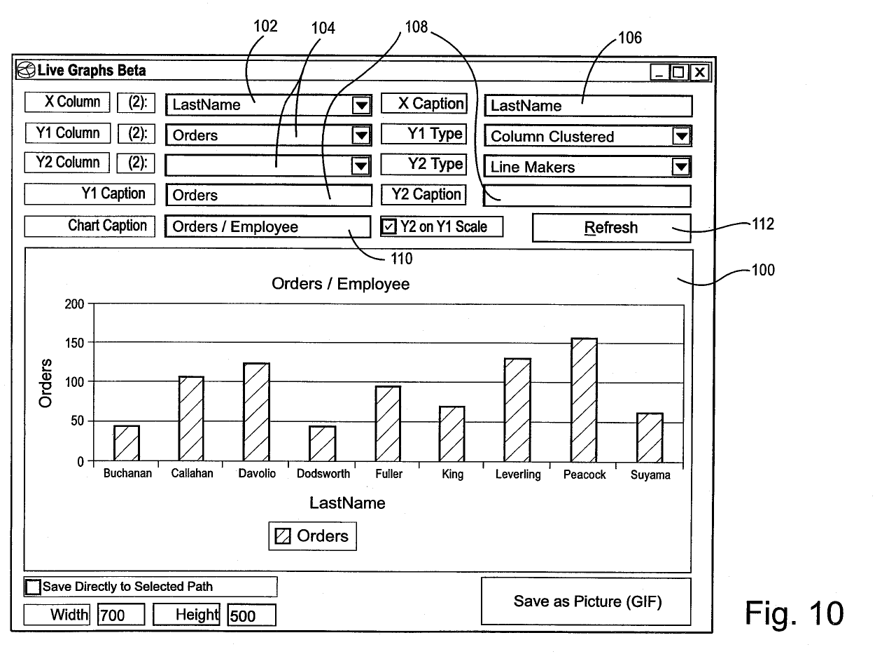

FIG. 10 illustrates a dynamic chart generated upon the selection of button 82f in the GUI screen display illustrated in FIG. 9. The SQL query illustrated in SQL query window 70 has been executed in response to the database platform selected in row selector 10 (an MS-Access® database platform rather than an Oracle® database platform as illustrated in FIGS. 2-8) and the selection of a particular data source in window 16a. As illustrated at the top of FIG. 9, browse button 17 and data source window 16a are presented by the GUI upon the selection on the database platform MS-Access® in row selector 10. Row selector 10 thus allows the database platform being explored to be easily switched to another database platform. Browse button 17 allows searching through available data sources (in this example data files) listed in window 16a. The remaining windows of the GUI remain essentially the same as the windows and buttons described in FIGS. 2-8.

Display grid 30 illustrated in FIG. 9 displays the results of the execution of the SQL in SQL query window 70. Specifically, display grid 30 displays two columns “Orders” and “LastName”. After selecting chart button 82f, a dynamic chart resembling FIG. 10 appears. Specifically, a blank dynamic chart appears. The blank dynamic chart includes a display area 100, X and Y columns 102, 104, X and Y captions 106 and 108 and a chart caption 110. The user may define the X and Y columns, X and Y captions and chart captions as illustrated in FIG. 10. After the X and Y columns and X and Y captions and chart captions have been filled in windows 102-110, refresh button 112 may be selected to generate and display the chart illustrated in display area 100. The display screens illustrated in FIGS. 9 and 10 may be displayed on a computer monitor of personal computer 2 simultaneously.

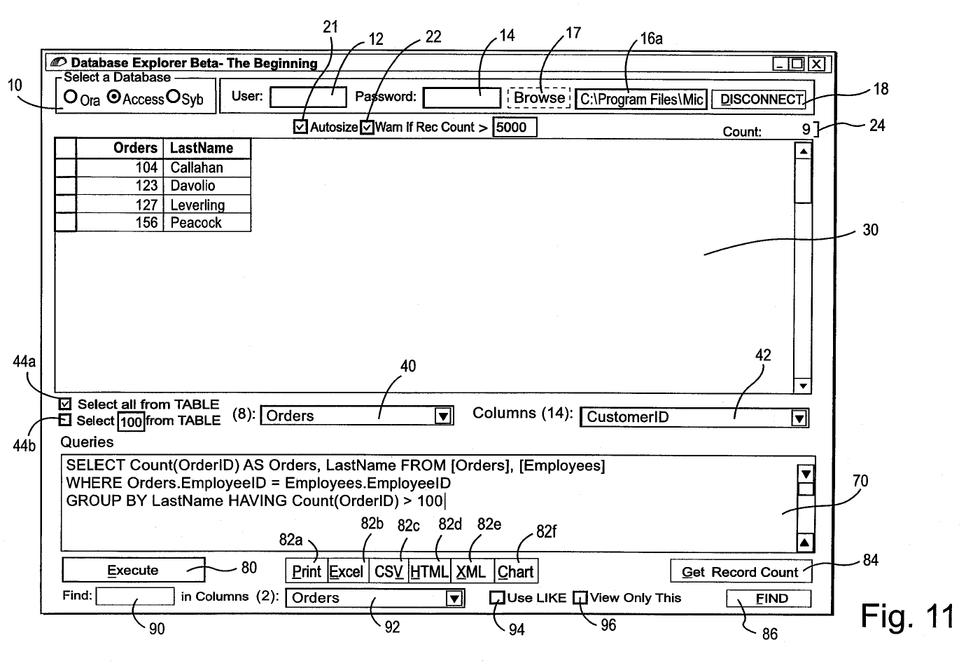

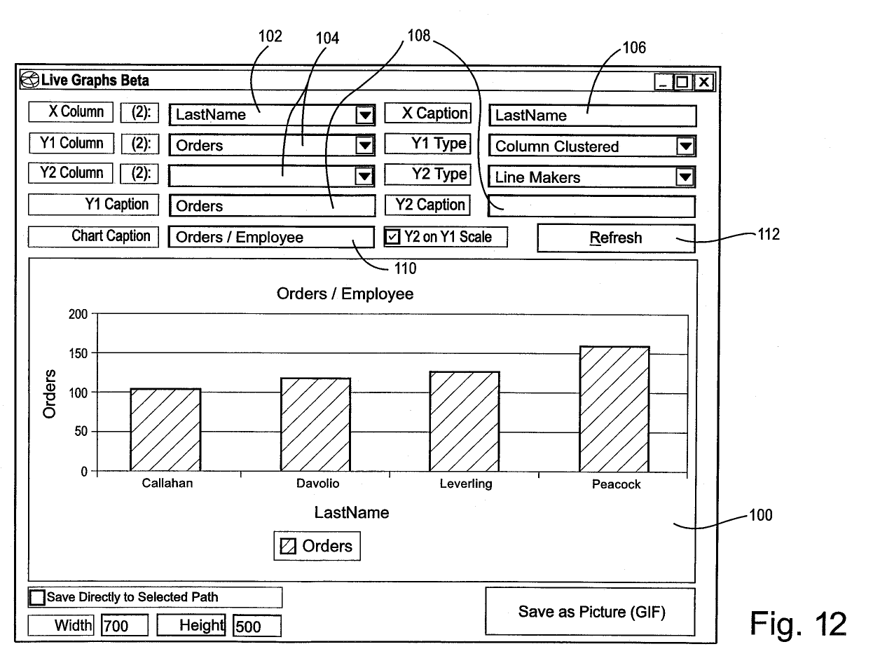

FIG. 11 illustrates a modification to the SQL query presented in the GUI screen display of FIG. 9. Specifically, the SQL query in SQL query window 70 has been modified by adding the text “HAVING COUNT (ORDERID)>100”. This modification to the SQL query may be made directly to the text of window 70 and subsequent selection of the execute button 80. Alternatively, the modification illustrated in FIG. 11 may be made through appropriate input in the windows 90 and 92, one of boxes 94 or 96 and subsequent selection of find button 86. Once the execute button 80 or find button 86 is selected to initiate processing of the modified SQL, the chart illustrated in FIG. 10 will be automatically changed so that it appears like the chart illustrated in FIG. 12. Accordingly, through the prior selection of chart button 82f, the chart illustrated in FIG. 10 may be dynamically changed to the chart illustrated in FIG. 12 once the changes to the SQL in window 70 are made as illustrated in FIG. 11.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. In a computer system, a method of searching through metadata from a plurality of data tables concurrently, the data tables being defined by a schema and stored in a database(s), the method comprising:
generating a graphical user interface, the graphical user interface having at least one item including a predefined instruction label which is associated with a corresponding SQL query for defining a search through the metadata from the plurality of data tables;
receiving user input, through the graphical user interface, selecting the schema and selecting the item having the predefined instruction label; and
processing the received user input so as to conduct a concurrent search through metadata from the plurality of tables, the type of search being based on the selected item having the predefined instruction label.

2. A method of claim 1, wherein each of the tables includes at least one column and the concurrent search through metadata from the plurality of tables involves concurrently searching for column names of the plurality of tables defined by the schema.

3. A method of claim 1, wherein the graphical user interface includes a user select menu allowing selection of the item having the predefined instruction label associated with the corresponding SQL query from among a list having at least one other item having another predefined instruction label associated with another SQL query.

4. A method of claim 1, further comprising outputting data obtained as a result of the search in a dynamic chart.

5. A method of claim 1, wherein the SQL query associated with the predefined instruction label of the selected item is displayed in a window defined by the graphical user interface, the SQL query being modifiable through change(s) input through the window or through a separate SQL query modification window also defined by the graphical user interface.

6. In a computer system including a first database having a first data platform format and a second database having a second data platform format which is different than the first data platform format, a method comprising:
generating a graphical user interface including a user input portion for enabling user selection of one of the first and second databases and allowing the user to switch access between the first and second databases;
receiving a user selection of one of the first and second databases through the user input portion of the graphical user interface;
updating the graphical user interface upon receipt of at least the user selection of one of the first and second databases so that the graphical user interface presents a plurality of schemas defining organization of a plurality of tables in the selected database and at least one item including a predefined instruction label associated with a corresponding SQL query for defining a search through metadata from a plurality of tables defined by a particular schema;
receiving user input, through the graphical user interface, selecting one of the schemas and selecting the item having the predefined instruction label for defining a search through metadata from a plurality of tables defined by the selected schema; and
processing the received user input so as to conduct a concurrent search through metadata from the plurality of tables, the type of search being based on the selected schema and the selected item.

7. A method of claim 6, wherein each of the tables includes at least one column and the concurrent search through metadata from the plurality of tables defined by the schema involves concurrently searching for column names of the plurality of tables defined by the schema.

8. A method of claim 6, wherein the updated graphical user interface includes a user select menu allowing selection of the item having the predefined instruction label associated with the corresponding SQL query from among a list having at least one other item having another predefined instruction label associated with another SQL query.

9. A method of claim 6, further comprising outputting data obtained as a result of the search in a dynamic chart.

10. A method of claim 6, wherein the SQL query associated with the selected predefined instruction label of the selected item is displayed in a window defined by the updated graphical user interface, the SQL query being modifiable through change(s) input through the window or through a separate SQL query modification window defined by the updated graphical user interface.

11. A computerized graphical user interface capable of searching through metadata from a plurality of data tables defined by a schema and stored in a database, the graphical user interface comprising:
a user selection menu including a list of items having respective predefined instruction labels associated with respective SQL queries each of which defines a search through the metadata from the plurality of data tables defined by the schema; and
a display window displaying the results of a processed SQL query that corresponds to the predefined instruction label of the item that is selected by the user utilizing the user selection menu from among the list of items, the processing of the SQL query including conducting a concurrent search through metadata from the plurality of tables, the type of concurrent search being based on the selected item.

12. A computerized graphical user interface of claim 11, wherein the concurrent search through metadata from the plurality of tables involves concurrently searching for column names of the plurality of tables.

13. A computerized graphical user of claim 11 further comprising a user selectable button for enabling generation of a dynamic chart reflecting the results of the processed SQL query.

14. A computerized graphical user interface of claim 11 further comprising a query window displaying the SQL query associated with the predefined instruction label of the selected item, the SQL query being modifiable through change(s) input through the query window or through a separate SQL query modification window defined by the graphical user interface.
